(19) United States
(12) Patent Application Publication
(10) Pub. No.: US 2024/0169694 A1
(43) Pub. Date: May 23, 2024

(54) METHOD AND SERVER FOR CLASSIFYING APPAREL DEPICTED IN IMAGES AND SYSTEM FOR IMAGE-BASED QUERYING

(71) Applicant: Queenly, Inc., San Francisco, CA (US)

(72) Inventors: Mengzhou Zhou, San Francisco, CA (US); Micaella Morales, Hayward, CA (US)

(21) Appl. No.: 18/511,161

(22) Filed: Nov. 16, 2023

Related U.S. Application Data
(60) Provisional application No. 63/384,124, filed on Nov. 17, 2022.

(51) Int. Cl. G06V 10/764; G06F 16/535; G06F 16/583; G06V 10/26; G06V 10/46; G06V 10/56; G06V 10/75; G06V 40/10

(52) U.S. Cl. CPC G06V 10/764; G06F 16/535; G06F 16/5854; G06V 10/267; G06V 10/476; G06V 10/56; G06V 10/759; G06V 40/103

(57) ABSTRACT

Many clothing listings, particularly in the secondhand market, lack comprehensive or standardized information about the product's attributes, making it difficult for consumers to find what they need. A method and server for classifying images depicting apparel items based on reference shapes is provided. Images depicting apparel are classified based on reference shapes and a geometrical model of the body. A method and system for querying images based on the classification is further provided.

### CROSS-REFERENCE TO RELATED APPLICATION

This application claims the benefit of U.S. Provisional Patent Application No. 63/384,124 entitled SYSTEMS AND METHODS FOR SHAPE RECOGNITION AND HUMAN BODY POSE DETECTION TO CLASSIFY FASHION PRODUCTS, filed Nov. 17, 2022, the entire contents of which are incorporated herein by reference.

### FIELD

The present specification is directed to computer-assisted methods for analyzing images, and particular methods of classifying apparel depicted in images.

### BACKGROUND

Searching for clothing through word-based queries is often inefficient due to the inadequacy of product attributes in retail listings. Many clothing listings, particularly in the secondhand market, lack comprehensive or standardized information about the product's attributes, making it difficult for consumers to find what they need. Even when product attributes are included, consumers may not be familiar with the technical terminology required for effective word searches.

Furthermore, reverse image searching is ill-suited to clothing for several reasons. Clothing items are highly deformable, which means they can look vastly different in various camera angles, body shapes, body positions, and lighting conditions. This deformability poses a significant challenge for reverse image search algorithms to provide accurate and relevant results. As a result, computing and networking resources are wasted in futile attempts to locate specific clothing items.

### SUMMARY

To improve the efficiency of reverse image searching, a method and server are provided which compares an input image to a database of reference shapes in order to classify apparel items.

One aspect of the present disclosure provides a method for classifying apparel in images. The method includes receiving at a computing device an image depicting an apparel item and a body, at a processor connected to the computing device, segmenting the image into at least a body region corresponding to the body and an apparel region corresponding to the apparel item, retrieving a plurality of reference shapes from memory at the computing device, at the processor, computing a matching score for each of the reference shapes, the matching score representing a comparison of the respective reference shape to the body region and the apparel region, and at the processor, selecting one of the reference shapes based on a comparison of the matching scores.

In some embodiments, segmenting the image includes differentiating colors in the image, determining a boundary of the apparel region based on the color differentiation, and determining a boundary of the body region based on the color differentiation.

In some embodiments, the method further includes generating a geometric model of the body based on the segmentation, wherein computing a matching score for each of the reference shapes includes comparing the respective reference shape to the geometric model.

In some embodiments, the geometric model of the body comprises a plurality of body coordinates connected by vectors.

In some embodiments, generating the geometric model of the body includes detecting keypoints corresponding with the body depicted in the image, assigning one of the body coordinates to each of the keypoints, and connecting the body coordinates with the vectors.

In some embodiments, generating the geometric model of the body includes estimating a pose based on the boundary of the body region and the boundary of the apparel region, locating the plurality of body coordinates in the image based on the pose, and connecting the body coordinates with vectors.

In some embodiments, computing the matching score for each of the reference shapes includes comparing the respective reference shape to the geometric model of the body.

It is another aspect of the present disclosure to provide a non-transitory computer-readable medium including instructions for classifying images. The instructions are for receiving at a computing device an image depicting an apparel item and a body, at a processor connected to the computing device, segmenting the image into at least a body region corresponding to the body and an apparel region corresponding to the apparel item, retrieving a plurality of reference shapes from memory at the computing device, at the processor, computing a matching score for each of the reference shapes, the matching score representing a comparison of the respective reference shape to the body region and the apparel region, and at the processor, selecting one of the reference shapes based on a comparison of the matching scores.

In some embodiments, the instructions for segmenting the image include differentiating colors in the image, determining a boundary of the apparel region based on the color differentiation, and determining a boundary of the body region based on the color differentiation.

In some embodiments, the instructions are also for generating a geometric model of the body based on the segmentation, wherein computing a matching score for each of the reference shapes includes comparing the respective reference shape to the geometric model.

In some embodiments, the geometric model of the body includes a plurality of body coordinates connected by vectors.

In some embodiments, the instructions for generating the geometric model of the body include detecting keypoints corresponding with the body depicted in the image, assigning one of the body coordinates to each of the keypoints, and connecting the body coordinates with the vectors.

In some embodiments, generating the geometric model of the body includes: estimating a pose based on the boundary of the body region and the boundary of the apparel region, locating the plurality of body coordinates in the image based on the pose, and connecting the body coordinates with vectors.

In some embodiments, computing the matching score for each of the reference shapes includes comparing the respective reference shape to the geometric model of the body.

It is a further aspect of the present disclosure to provide a method for querying images. The method includes receiving a plurality of product images at a server, classifying the product images according to the above-described methods, at the server, receiving a query image from a user device via a network, classifying the query image according to the above-described methods, comparing the query image to the product images and computing a plurality of relevance scores based on the comparison, comparing the relevance scores, and transmitting a portion of the product images to a user device based on the comparison of the relevance scores.

It is a further aspect of the present disclosure to provide a system for querying images, the system includes a network, a user device configured to transmit a query image via the network, and a server comprising a processor. The server is configured to classify a plurality of product images according to the above-described methods and store the plurality of product images in memory at the server, receive the query image from the user device, classify the query image according to the above-described methods, compare the query image to the plurality of product images and compute a relevance score for the plurality of product images based on the comparison, compare the relevance scores, and transmit a portion of the product images to the user device based on a comparison of the relevance scores.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Embodiments are described with reference to the following figures.

FIG. 1 is a schematic diagram of a server for classifying apparel depicted in images.

FIG. 2 is a flowchart of a method for classifying apparel depicted in images.

FIG. 3 is an illustration of image 300 according to exemplary performance of block 204 of the method of FIG. 2.

FIG. 4 is an illustration of segmented image 400 according to exemplary performance of block 208 of the method of FIG. 2.

FIG. 5 is a flowchart depicting exemplary performance of block 208 of the method of FIG. 2.

FIG. 6 is a flowchart depicting exemplary performance of the method of FIG. 2.

FIG. 7 is a flowchart depicting exemplary performance of block 516 of the method of FIG. 5.

FIG. 8A is an illustration of a reference shape according to exemplary performance of block 212 of the method of FIG. 2.

FIG. 8B is an illustration of another reference shape according to exemplary performance of block 212 of the method of FIG. 2.

FIG. 8C is an illustration of another reference shape according to exemplary performance of block 212 of the method of FIG. 2.

FIG. 8D is an illustration of another reference shape according to exemplary performance of block 212 of the method of FIG. 2.

FIG. 9A is an illustration of another reference shape according to exemplary performance of block 212 of the method of FIG. 2.

FIG. 9B is an illustration of another reference shape according to exemplary performance of block 212 of the method of FIG. 2.

FIG. 9C is an illustration of another reference shape according to exemplary performance of block 212 of the method of FIG. 2.

FIG. 9D is an illustration of another reference shape according to exemplary performance of block 212 of the method of FIG. 2.

FIG. 10 is an illustration depicting exemplary performance of block 216 of the method of FIG. 2.

FIG. 11 is an illustration depicting exemplary performance of block 216 of the method of FIG. 2.

FIG. 12 is an illustration depicting exemplary performance of block 216 of the method of FIG. 2.

FIG. 13 is a schematic diagram showing a system for image-based querying, including the server of FIG. 1.

FIG. 14 is a flowchart showing a method for image-based querying.

FIG. 15 is a flowchart showing another method for classifying apparel depicted in images.

FIG. 16 is a flowchart showing another method for classifying apparel depicted in images.

### DETAILED DESCRIPTION

The present disclosure pertains to a server for classifying apparel depicted in images. The server is configured to receive an image depicting an apparel item and segment the image into at least a body region and an apparel region. Reference shapes are retrieved from memory at the server. The server computes a matching score for each of the reference shapes based on a comparison of the respective reference shape to the body region and the apparel region. The server selects one of the reference shapes based on a comparison of the matching scores for the reference shapes.

The methods, functionality, and other techniques discussed herein may be carried out by instructions, which may be directly executable (e.g., a binary file), indirectly executable (e.g., bytecode), interpreted (e.g., a script), or otherwise executable by a processor. Instructions may be stored in a non-transitory computer-readable medium, such as a memory, hard drive, or similar device.

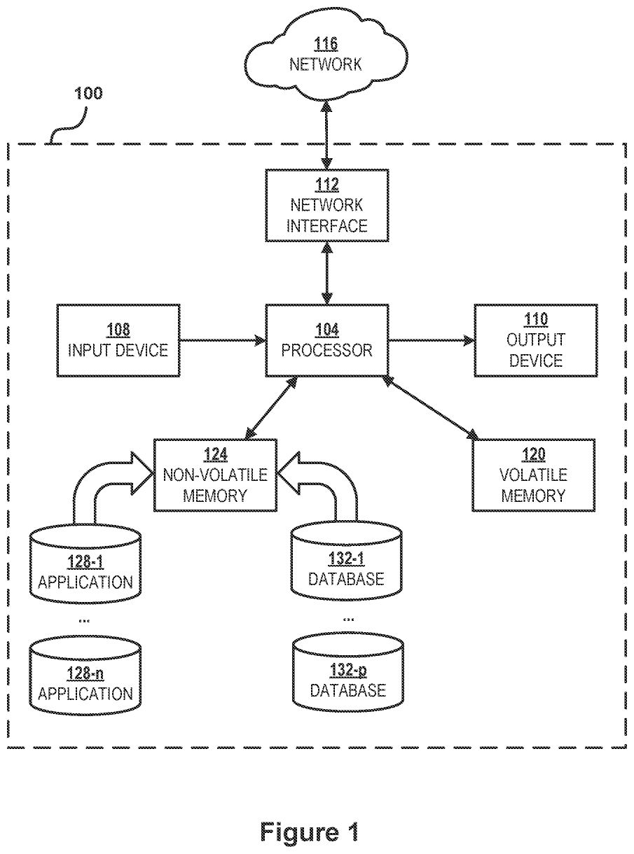

FIG. 1 is a schematic of a server 100 for classifying apparel in images according to a non-limiting embodiment.

Server 100 includes a processor 104 which may be implemented as a plurality of processors or one or more multi-core processors. Processor 104 may be configured to execute different programming instructions responsive to an input received at an input device 108 and to control an output device 110. Input device 108 can include a traditional keyboard and/or mouse to provide physical input, camera, or the like. Likewise output device 110 can be a display. In variants, additional and/or other input devices 108 or output devices 110 are contemplated or may be omitted altogether as the context requires. (For example, server 100 may include a network interface 112 for connecting to another device on network 116 that has an input (e.g., keyboard, mouse) and output device (e.g., monitor) to provide remote administrative control over server 100.)

To fulfill its programming functions, processor 104 is configured to communicate with one or more memory units including volatile memory 120 and non-volatile memory 124 (generically referred to herein as “memory”). Non-volatile memory 124 can be based on any persistent memory technology, such as an Erasable Electronic Programmable Read Only Memory (“EEPROM”), flash memory, solid-state hard disk (SSD), other type of hard-disk, or combinations thereof. Non-volatile memory 124 may also be described as a non-transitory computer readable media. Also, more than one type of non-volatile memory may be provided. Volatile memory 120 is based on any random-access memory (RAM) technology. For example, volatile memory 120 can be based on Double Data Rate (DDR) Synchronous Dynamic Random-Access Memory (SDRAM). Other types of volatile memory are contemplated.

Programming instructions in the form of applications 128-1, 128-2 . . . 128-n (generically referred to herein as “application 128” or collectively as “applications 128”. This nomenclature is used elsewhere herein.) are typically maintained, persistently, in non-volatile memory 124 and used by processor 104 which reads from and writes to volatile memory 120 during the execution of applications 128. One or more tables or databases 132 are maintained in non-volatile memory 124 for use by processor 104 during execution of applications 128.

It is to be understood that server 100 may be implemented as a virtual machine or with mirror images.

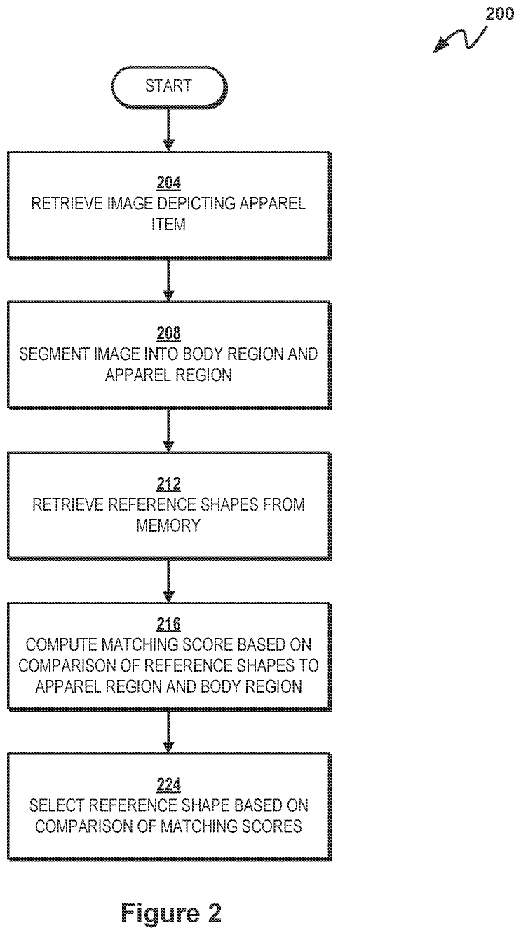

FIG. 2 is a flowchart showing a method 200 for classifying apparel depicted in images in accordance with another embodiment of the disclosure. Persons skilled in the art may choose to implement method 200 on server 100 or variants thereon, or with certain blocks omitted, performed in parallel or in a different order than shown. Method 200 can thus also be varied. In embodiments where method 200 is performed on server 100, method 200 is performed by processor 104.

Block 204 comprises retrieving an image depicting an apparel item and a body. Block 204 is performed by processor 104 which retrieves the image from memory or receives the image from input device 108 or from another device via network 116. The image may include one or more photographs, illustrations, three-dimensional images, or videos that depict the apparel item. The apparel item includes but is not limited to clothing, footwear, an accessory, jewelry, headwear, swimwear, luggage, a prosthetic, a medical brace or support, personal protective equipment (PPE), and combinations thereof. In some examples, the body is a person, however the body is not particularly limited. In other examples, the body is a pet, mannequin, dress form, or other support.

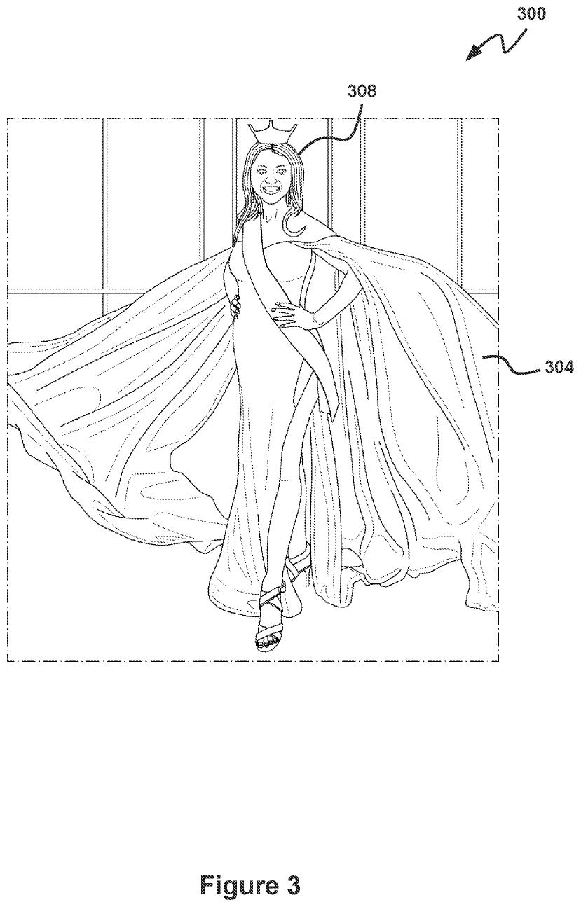

A non-limiting example of image 300 is shown in FIG. 3. In FIG. 3, image 300 is a photograph depicting apparel item 304 and body 308. In this example, apparel item 304 is a dress and body 308 is a human woman. The dress depicted in FIG. 3 will be used as an illustrative example herein, however a skilled person will understand that server 100 and method 200 are not particularly limited to classifying images of dresses and that other apparel items are contemplated.

As part of block 204, processor 104 may further retrieve image data associated with image 300. The image data may include, but is not limited to, geolocation data, a date and time, a caption, alternative (alt) text, a description, a keyword, a tag, a color profile, photo orientation, file name, author, copyright ownership, the like, and combinations thereof. Generally, the image data varies depending on the source of the image. For example, if image 300 is received from a server hosting a retail website, the image data may include a product name, a stock keeping unit (SKU), a product description, a product category, customer reviews, and the like. If image 300 is received from a social media server, the image data may include an image caption, user comments and replies, geolocation data, hashtags, image filters, and the like.

At block 208, processor 104 segments image 300 into an apparel region corresponding to the apparel item 304 and a body region corresponding with the body 308. The apparel region includes a portion of the image depicting the visible portions of the apparel item while the body region includes a portion of the image depicting the visible portions of the body. In some examples, at least one region of the image is identified as neither the body region nor the apparel region. Specific non-limiting examples of segmentation techniques are described herein, however processor 104 may segment image 300 by any suitable technique known in the art including edge-based segmentation, threshold-based segmentation, region-based segmentation, cluster-based segmentation, and watershed segmentation. As part of block 208, processor 104 may segment the image into a foreground region and a background region. After identifying the foreground region, processor 104 may further segment the foreground region into the apparel region and the body region. In some examples, processor 104 identifies two apparel regions in image 300.

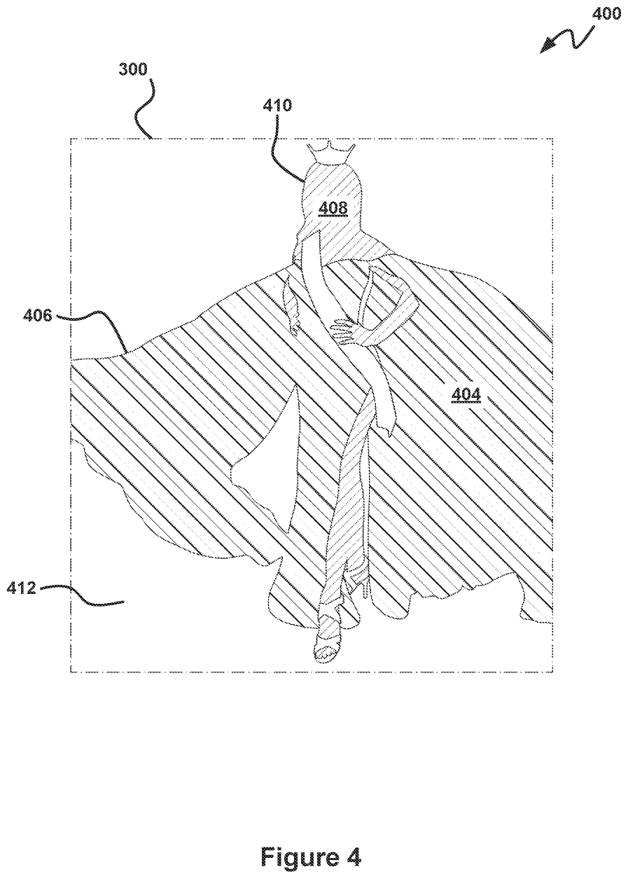

An exemplary output of block 208 is shown generally at 400 in FIG. 4. FIG. 4 illustrates image 300 of FIG. 3 segmented into an apparel region 404 defined by apparel boundary 406 and a body region 408 defined by body boundary 410. In the non-limiting example shown in FIG. 4, apparel region 404 is a portion of image 300 that depicts the dress while body region 408 is a portion of image 300 that depicts the woman wearing the dress. The background region is indicated at 412. In this example, processor 104 identified a single apparel region 404, but in other non-limiting examples, processor 104 may identify a plurality of apparel regions corresponding to the shoes, sash, and/or crown.

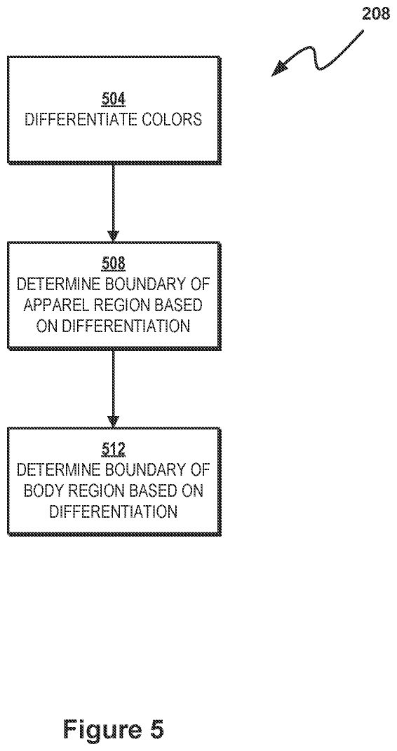

Exemplary performance of block 208 is illustrated in FIG. 5.

At block 504, processor 104 differentiates colors in image 300. Differentiating colors comprises comparing the pixels in image 300 based on one or more color properties. Non-limiting examples of color properties include lightness, opacity, intensity, hue, and saturation. In some examples, block 504 includes evaluating the pixels with a color model and differentiating the pixels according to that color model. Suitable color models include an HSL (hue, saturation, lightness) model, an HSV (hue, saturation, value) model, an RGB (red, green, blue) model, and a CMYK (cyan, magenta, yellow and black) model. In some examples, block 504 includes converting image 300 into a grayscale image and differentiating the pixels based on single pixel intensity value in the grayscale image.

At block 508, processor 104 determines an apparel boundary 406 defining apparel region 404. Block 508 comprises clustering a portion of the pixels in image 300 according to the color differentiation at block 504.

In one example, block 508 includes sampling one or more pixels in one or more apparel sampling regions of image 300 corresponding to the apparel item. The one or more apparel sampling region may correspond to the bust or bikini area of the body, since the bust and bikini areas are most likely to be covered by clothing. The non-sampled pixels in image 300 are compared to the sampled pixels. If one pixel is sampled, processor 104 compares the non-sampled pixels of image 300 to the one sampled pixel. If two or more pixels are sampled, processor 104 compares the non-sampled pixels of image 300 to a dominant color of the sampled pixels. Based on the comparison, processor 104 calculates a likelihood score for each pixel, the likelihood score representing the probability that the respective pixel corresponds to the apparel item. Processor 104 may be further programmed with a predetermined threshold, and if the likelihood score meets or exceeds the predetermined threshold, processor 104 will include the respective pixel in the apparel region 404.

In examples where processor 104 samples one or more pixels in two apparel sampling regions, processor 104 may be configured to identify two or more apparel regions. If the one or more pixels sampled in a first apparel sampling region are sufficiently different from the one or more pixels sampled in a second apparel sampling region, processor 104 may cluster pixels into two apparel regions. In a specific non-limiting example, the person depicted in the image is wearing a red shirt and blue jeans and processor 104 determines that there are two apparel regions: a first apparel region corresponding to the shirt, and a second apparel region corresponding to the blue jeans.

At block 512, processor 104 determines a body boundary 410 defining body region 408. Block 512 comprises clustering a portion of the pixels in image 300 according to the color differentiation at block 504.

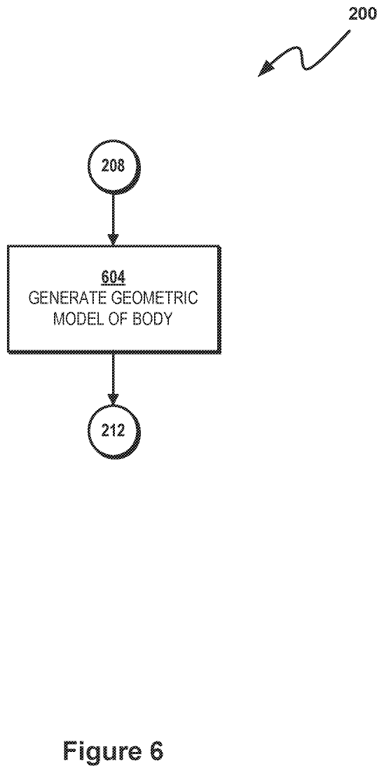

In one example, block 512 includes sampling one or more pixels in one or more body sampling regions image 300 corresponding to the skin of the body. The one or more body sampling regions may correspond with the hand or face of the body since the hands and face are typically exposed in images. The non-sampled pixels in image 300 are compared to the sampled pixels. If one pixel is sampled, processor 104 compares the non-sampled pixels of image 300 to the one sampled pixel. If two or more pixels are sampled, processor 104 compares the non-sampled pixels of image 300 to a dominant color in the sampled pixels. Based on the comparison, processor 104 calculates a likelihood score for each pixel, the likelihood score representing the probability that the respective pixel corresponds to the body. Processor 104 may be further programmed with a predetermined threshold, and if the likelihood score meets or exceeds the predetermined threshold, processor 104 will include the respective pixel in the body region 408. As shown in FIG. 6, some implementations of method 200 further include generating a geometric model of the body depicted in image 300. Block 604 may be performed after the segmentation at block 208. Block 604 is performed by processor 104 and comprises generating the geometric model based on the segmentation at block 208. The geometric model may include one of more body coordinates connected by vectors, however the geometric model is not particularly limited. As will be described in further detail, the body coordinates define locations in image 300 which represent landmarks or keypoints for the body. The keypoints may include an elbow, knee, wrist, hip, ankle, eye, nose, neck, hand, finger, thumb, shoulder, and the like.

In one embodiment, generating the geometric model includes detecting a plurality of keypoints corresponding with the body depicted in image 300. Locating the plurality of body coordinates is based on body region 408 and may be further based on apparel region 404. Since the apparel item is worn by the body, keypoints may be identified both in body region 408 and in apparel region 404. Any suitable technique may be used to locate the keypoints including machine learning, deep-learning-based algorithms and/or neural networks, or the like, which are trained to recognize features in images depicting bodies. In a specific, non-limiting embodiment, the keypoints are located using ML Kit™ Pose Detection API (Application Programming Interface) which is commercially available from Google (Mountainview, California). After detecting the keypoints, processor 104 may assign a body coordinate to each of the keypoints, the body coordinate indicating a pinpoint location or a region within image 300. Processor 104 may further connect the body coordinates with vectors. Generally, the vectors and body coordinates represent skeletal elements of the body.

In another embodiment, generating the geometric model includes approximating a silhouette based on the boundary of the body region and the boundary of the apparel region. Processor 104 may compute a combined boundary corresponding with the boundary of body region 408 and apparel region 404, the combined outline representing the outline of both the body and the apparel item. Based on the combined outline, processor 104 may approximate the silhouette of the body. Any suitable technique may be used to approximate the silhouette including machine learning, deep-learning algorithms and/or neural networks, or the like, which are trained to estimate body pose. Based on the estimated body pose, processor 104 may locate the body coordinates in image 300. Generally, processor 104 infers the location of the body coordinates based on the combined boundary. Typically, the body coordinates obtained through silhouette approximation comprise a range of coordinates indicating a general area in image 300. In a specific non-limiting example, processor 104 determines that the head corresponds to the highest y-coordinates in the body region 408 and the shoulders correspond to a region with slightly lower y-coordinates and a broader range of x-coordinates.

The machine learning algorithms, deep-learning algorithms and/or neural networks described above may include but are not limited to a generalized linear regression algorithm; a random forest algorithm; a support vector machine algorithm; a gradient boosting regression algorithm; a decision tree algorithm; a generalized additive model; evolutionary programming algorithms; Bayesian inference algorithms; reinforcement learning algorithms, and the like. To be clear, any suitable machine learning algorithm may be used to generate a geometric model of the body at block 604.

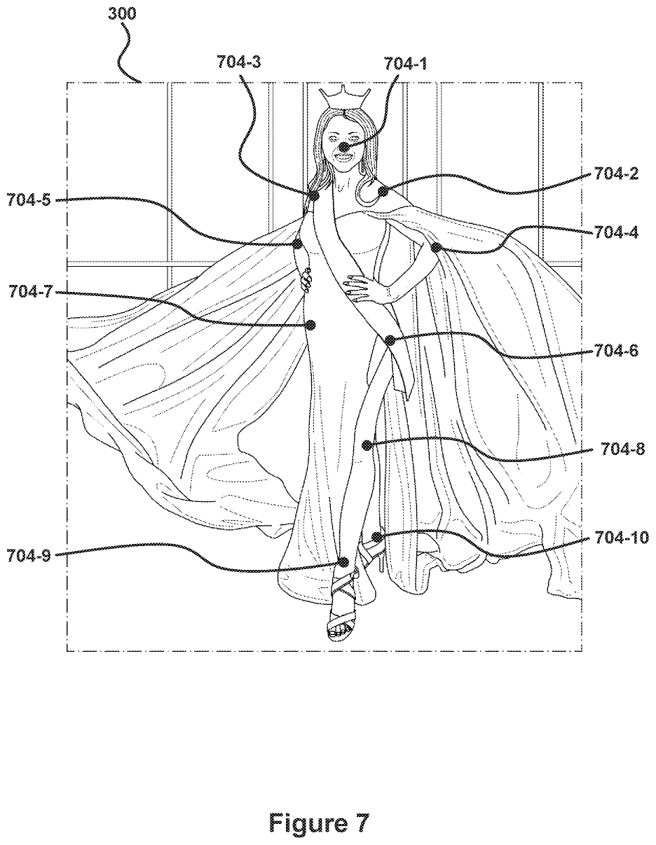

FIG. 7 is a schematic of the body coordinates 704 that were output at block 604 according to a non-limiting embodiment. FIG. 7 shows a plurality of body coordinates 704 identified in image 300. In this example, body coordinate 704-1 corresponds to the nose, body coordinate 704-2 corresponds to the left shoulder, body coordinate 704-3 corresponds to the right shoulder, body coordinate 704-4 corresponds to the left elbow, body coordinate 704-5 corresponds to the right elbow, body coordinate 704-6 corresponds to the left hip, body coordinate 704-7 corresponds to the right hip, body coordinate 704-8 corresponds to the left knee, body coordinate 704-9 corresponds to the left ankle, and body coordinate 704-10 corresponds to the right ankle.

Returning to FIG. 2, block 212 comprises retrieving a plurality of reference shapes from memory at server 100. Block 212 is performed by processor 104 which retrieves the plurality of reference shapes from database 132 stored in memory. In the examples described herein, the references shapes are two-dimensional polygons having a plurality of vertices and edges, however the reference shapes are not particularly limited. In other examples, the reference shapes may include shapes having one or more curved edges. In yet other examples, the reference shapes include three-dimensional shapes. The reference shapes may be stored in database 132 in association with one or more apparel properties. Generally, the reference shapes illustrate a variety of possible shapes for apparel items.

The apparel properties associated with each of the reference shapes may include an apparel identifier, a feature identifier, a variant identifier, and combinations thereof. The apparel identifier corresponds with a category of apparel item and may include “dress”, “pant”, “hat”, “footwear”, “bag”, or the like. The feature identifier corresponds with a design element of the apparel item and may include “skirt silhouette”, “sleeve”, “neckline”, “hemline”, or the like. The variant identifier corresponds with the style of the design element. For example, if the feature identifier is “skirt silhouette”, the variant identifier may include “ball gown”, “A-line”, “mermaid”, “side slit”, or the like. It should be understood that a reference shape may be associated with more than one apparel identifier. For example, reference shapes that depict a skirt silhouette may be associated with both “dress” and “skirt” apparel identifiers.

In some examples, only a portion of the reference shapes are retrieved from memory at block 212. The portion of the reference shapes may be selected according to the image data and one or more apparel properties associated with the reference shapes. In a specific non-limiting example, the image data indicates that the image depicts a dress and processor 104 retrieves only the reference shapes associated with the apparel identifier “dress”.

In examples where the reference shapes comprise a plurality of vertices, one or more of the vertices may be stored in database 132 in association with an alignment metric representing the intended alignment of the reference shape relative to the geometric model of the body. The alignment metric may comprise a keypoint identifier corresponding to a keypoint on the body. As will be described in greater detail herein, the keypoint identifier may indicate a body coordinate 704 in image 300 with which the respective vertex should be aligned. In a specific, non-limiting example, one of the reference shapes is associated with the apparel identifier “mermaid” and includes a vertex associated with a keypoint identifier corresponding to the left hip, indicating that the vertex V should be aligned with the body coordinate 704-6 for the left hip. The alignment metric may further comprise a distance and direction relative to a body coordinate. In a specific non-limiting example, one of the reference shapes is associated with the apparel identifier “ball gown” and includes a vertex associated with a keypoint identifier corresponding to the right foot. The alignment metric for the vertex indicates that the vertex has the same y-coordinate as body coordinate 704-10 corresponding to the right foot but has a different x-coordinate.

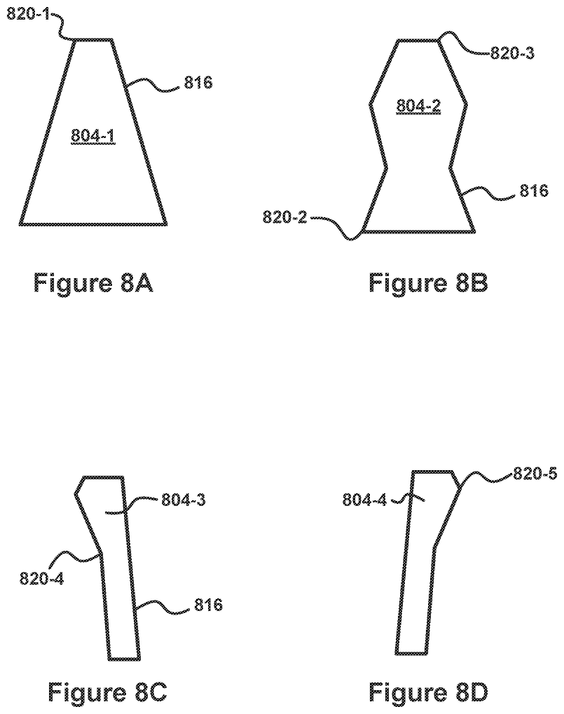

Non-limiting examples of reference shapes 804 are shown in FIGS. 8A to 8D. In these examples, the apparel identifier is “dress” or “skirt”, and the feature identifier is “skirt silhouette”. Reference shape 804-1 shown in FIG. 8A corresponds with the variant identifier “ball gown”. Reference shape 804-2 shown in FIG. 8B corresponds with the variant identifier “mermaid”. Reference shape 804-3 shown in FIG. 8C corresponds with the variant identifier “slide slit (right)”. Reference shape 804-4 shown in FIG. 8D corresponds with the variant identifier “side slit (left)”. Each reference shape 804 is defined by a plurality of edges 816 connecting a plurality of vertices 820.

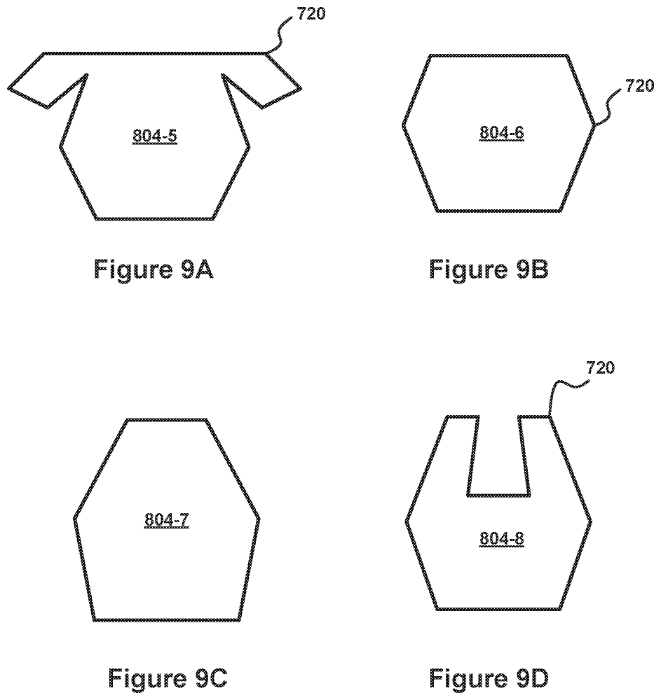

Further non-limiting examples of reference shapes 804 are shown in FIGS. 9A to 9D. In these examples, the reference shapes 804 are associated with the apparel identifiers “shirt” and “dress” and the feature identifier “neckline”. Reference shape 804-5 shown in FIG. 9A corresponds with the variant identifier “off the shoulder”. Reference shape 804-6 shown in FIG. 9B corresponds with the variant identifier “strapless”. Reference shape 804-7 shown in FIG. 9C corresponds with the variant identifier “halter-1”. Reference shape 804-8 shown in FIG. 9D corresponds with the variant identifier “halter-2”. Each reference shape 804 is defined by a plurality of edges 816 connecting a plurality of vertices 820.

To accommodate for the fluidity of apparel items, more than one reference shape may be associated with the same apparel properties. The plurality of reference shapes associated with a set of apparel properties may reflect a plurality of possible configurations of the apparel item. In a specific non-limiting embodiment, the variant identifier “mermaid” is associated with a first reference shape corresponding to the configuration of a mermaid dress when the wearer is standing upright, a second reference shape corresponding to the configuration of a mermaid dress when the wearer is seated, and a third reference shape corresponding to the configuration of a mermaid dress when the wearer is walking. A skilled person will now understand that any suitable number of reference shapes may be associated with a set of apparel properties.

The reference shapes retrieved at block 212 may be generated at server 100 prior to performance of method 200. Processor 104 may be trained to generate the reference shapes 804 using a neutral network or machine learning algorithm. Processor 104 may first categorize an apparel item depicted in a plurality of images and then generate a reference shape corresponding to said apparel item. The reference shapes 804 are then stored in memory.

Block 216 comprises comparing the reference shapes retrieved at block 212 to apparel region 404 and body region 408. Block 216 is performed by processor 104 which compares image 300 to each of the reference shapes and computes a matching score based on the comparison. The matching score represents the degree to which reference shape 804 accurately describes the style of the apparel item depicted in image 300. The matching score may include a numerical value, a color, a letter, a symbol, a word, the like, or a combination thereof. In the examples described herein, the processor computes the matching score as a numerical value which is assigned “high”, “medium”, or “low” according to pre-determined threshold. In these examples, “high” is assigned to a reference shape 804 with a high likelihood of matching the apparel item in image 300 and “low” is assigned to a reference shape 804 with a low likelihood of matching the apparel item in image 300. In a further non-limiting example, the matching score is a numerical value between 0 and 1 representing a percent chance that the reference shape will match the apparel item in image 300. In examples where processor 104 identifies two or more apparel regions at block 208, processor 104 may calculate a matching score for each of the apparel regions. As part of block 216, the matching score may be stored in volatile memory 120 or non-volatile memory 124 in association with the reference shape 804 and the image 300.

As part of the comparison, the reference shape 804 may be overlaid with image 300. In embodiments that include generating a geometric model of the body at block 604, one or more vertices of the reference shape 804 may be aligned relative to one or more body coordinates 704, according to the alignment metrics associated with each of the vertices 820. In a specific non-limiting example, vertex 820-3 is associated with the left hip and is aligned with body coordinate 704-6 representing the left hip of the body. As will be understood by a person of skill in the art, aligning two or more vertices 820 relative to two or more body coordinates 704 may cause the size and proportions of the reference shape 804 to change.

In embodiments that include generating a geometric model of the body at block 604, computing the matching score at block 216 further includes comparing the reference shape to the geometric model. In certain embodiments, computing the matching score is based on the calculated distance between at least one of the vertices 820 in reference shape 804 and at least one of the body coordinates 704. In some embodiments, the matching score is based on the fit between apparel boundary 406 and edges 816 of reference shape 804.

In further embodiments, the matching score is adjusted based on natural language processing. In examples where processor 104 receives image data associated with image 300, processor 104 may be configured to analyze the image data and adjust the matching score based on the image data. In one non-limiting example, the image data includes a verbal description of an asymmetrical neckline and processor 104 increases the matching score for the reference shape 804 corresponding to “asymmetrical neckline”. Processor 104 may further adjust the matching score according to the type and source of said image data. In a specific non-limiting example, the image data comprises a product description received from a retailer's website, describing the apparel item as “square neck”, and a product review describing the apparel item as “spaghetti strap”. Based on the image data, processor 104 is more likely to compute a “high” matching score for the “square neck” reference shape than for the “spaghetti strap” reference shape.

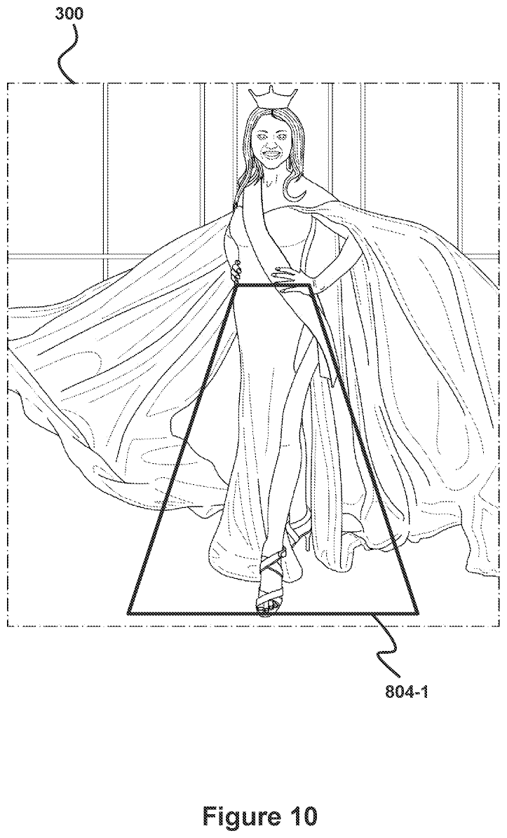

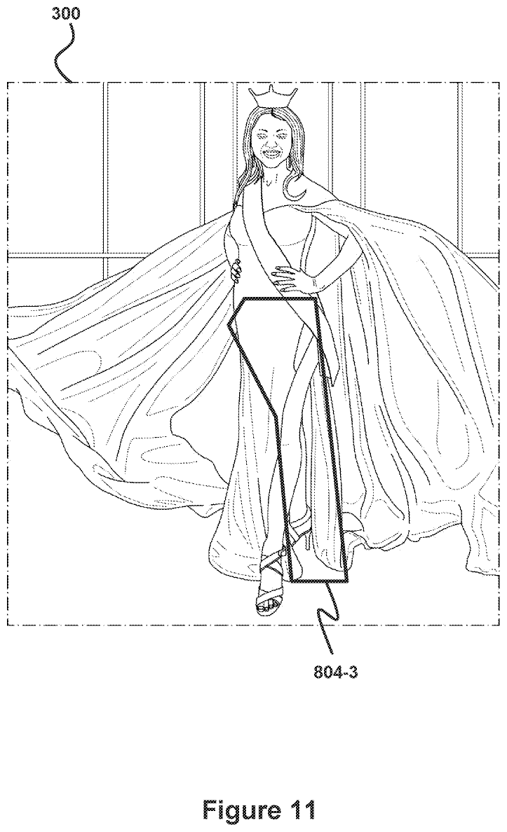

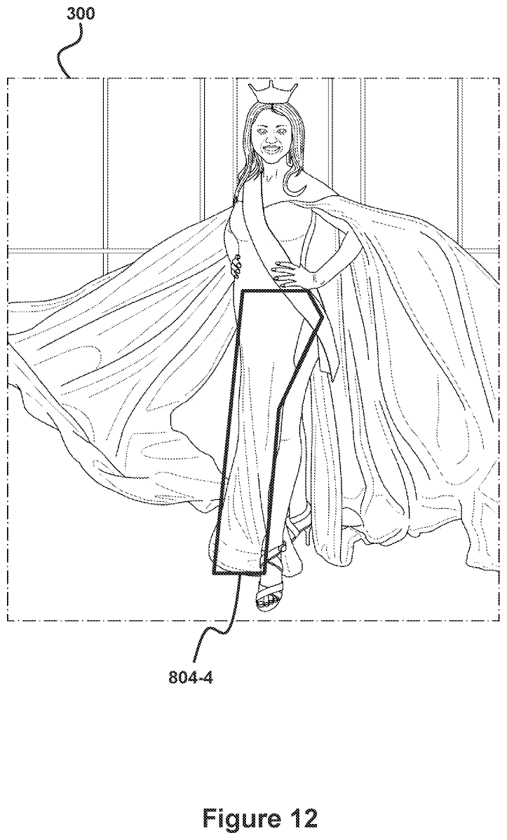

FIGS. 10 to 12 illustrate exemplary performance of block 216 according to one embodiment. In FIG. 10, reference shape 804-1 is compared with apparel region 404 in image 300. Processor 104 generates a “low” matching score for reference shape 804-1 and stores the matching score in memory in association with image 300. In FIG. 11, reference shape 804-3 is compared with apparel region 404 in image 300. Processor 104 generates a “medium” matching score for reference shape 804-3 and stores the matching score in memory in association with image 300. In FIG. 12, reference shape 804-4 is compared with apparel region 404 in image 300. Processor 104 generates a “high” matching score for reference shape 804-4 and stores the matching score in memory in association with image 300.

Block 224 comprises selecting at least one of the reference shapes based on a comparison of the matching scores generated at block 216. Block 224 is performed by processor 104 which compares the matching scores and selects at least one of the reference shapes 804 according to the comparison.

In some embodiments, processor 104 selects a single one of the reference shapes 804. The selected one of the reference shapes 804 may have the highest matching score.

In other embodiments, processor 104 selects a plurality of reference shapes 804. There are a number of possible methods by which processor 104 may select a plurality of reference shapes 804. In one example, two or more of the reference shapes 804 share the highest matching score, and processor 104 selects all of the reference shapes 804 having the highest matching score. In another example, a plurality of matching scores is within a predetermined range of the highest matching score, and processor 104 selects a plurality of reference shapes 804 corresponding with the plurality of matching scores. In a further example, processor 104 compares the matching scores to a pre-determined minimum and selects the reference shapes 804 corresponding to matching scores that meet or exceed the pre-determined minimum. It should be understood that selecting multiple reference shapes may be appropriate when an image is ambiguous or unclear, and the apparel item matches multiple reference shapes.

In embodiments where reference shapes are selected according to a pre-determined minimum, processor 104 may select none of the reference shapes 804. If none of the reference shapes 804 meet or exceed the pre-determined minimum, processor 104 does not select a reference shape.

In embodiments where reference shapes are stored in memory in association with a feature identifier, processor 104 may select a plurality of reference shapes corresponding with a plurality of the apparel identifiers. In embodiments where reference shapes are stored in memory in association with a feature identifier, processor 104 may select a plurality of the reference shapes corresponding with a plurality of the feature identifiers. Generally, selecting a plurality of reference shapes allows processor 104 to characterize multiple features depicted in image 300.

In the non-limiting example of image 300 shown in FIG. 3, processor 104 selects at least one reference shape associated with the feature identifier “skirt”, specifically reference shape 804-4 corresponding to the variant identifier “side slit (left)”. Processor 104 further selects at least one reference shape associated with the feature identifier “neckline”, specifically reference shape 804-5, corresponding to the variant identifier “off the shoulder”. In this example, processor 104 may not select any of the reference shapes 804 associated with the feature identifier “pant leg” since the matching scores for the relevant reference shapes fail to meet a pre-determined threshold.

As part of block 224, processor 104 may store the at least one selected reference shape in memory in association with image 300. Server 100 may further store the matching score corresponding to the respective selected reference shape 804 in memory.

In view of the above, it will now be apparent that variants, combinations, and subsets of the foregoing embodiments are contemplated. For example, while method 200 was discussed above in relation to photographs, image 300 may comprise a video depicting the apparel item. In these examples, method 200 may be repeated for a plurality of frames in the video and processor 104 may calculate a representative matching score for the reference shape, the representative score corresponding to an average, median, or mode of the matching scores computed for the plurality of frames.

In further embodiments, block 224 is omitted and processor 104 does not select at least one of the reference shapes. In these embodiments, the matching scores for all the reference shapes retrieved at block 212 may be stored in memory at server 100.

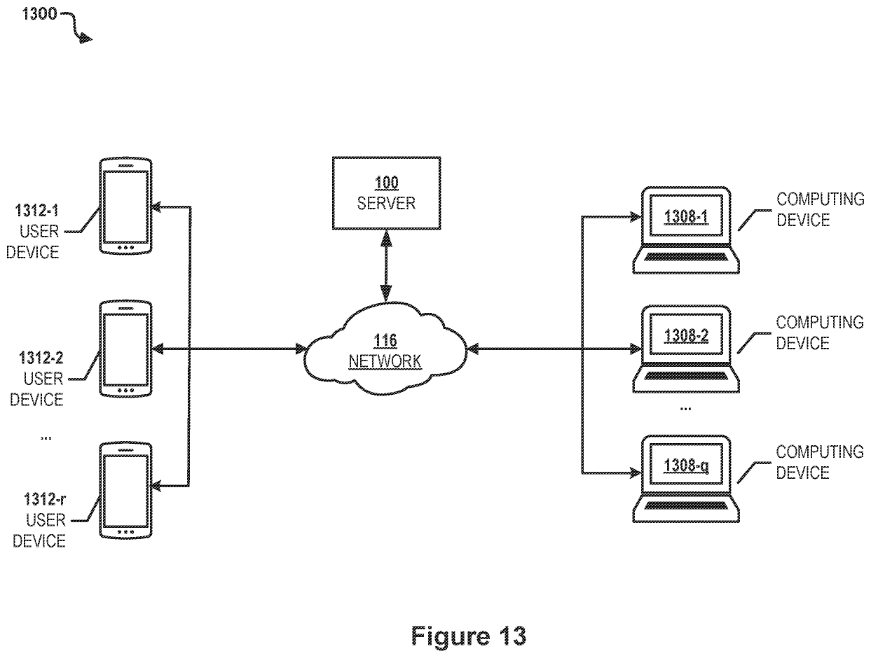

Method 200 may be used to improve image searching or reverse image searching for apparel. A system for querying images is provided generally at 1300 in FIG. 13. System 1300 includes network 116 connected to server 100. Network 116 is further connected to a plurality of computing devices 1308 and a plurality of user devices 1312.

Computing device 1308 can be a personal computer, smartphone, tablet computer, server, and any other device that can be configured to transmit a product image to server 100. Computing device 1308 may be further configured to transmit a product description to server 100.

User device 1312 can be a personal computer, smartphone, tablet computer, and any other device that can be configured to transmit a query to server 100, the query including a query image. User device 1312 is further configured to receive one or more product images from server 100.

Server 100 may be configured to store in memory a plurality of product images received from computing device 1308.

Generally, computing devices 1308 represent sellers offering apparel items for sale on a marketplace hosted at server 100. User devices 1312 represent purchasers searching for apparel items. Accordingly, method 200 may be applied to assist purchasers in locating apparel items in a desired style.

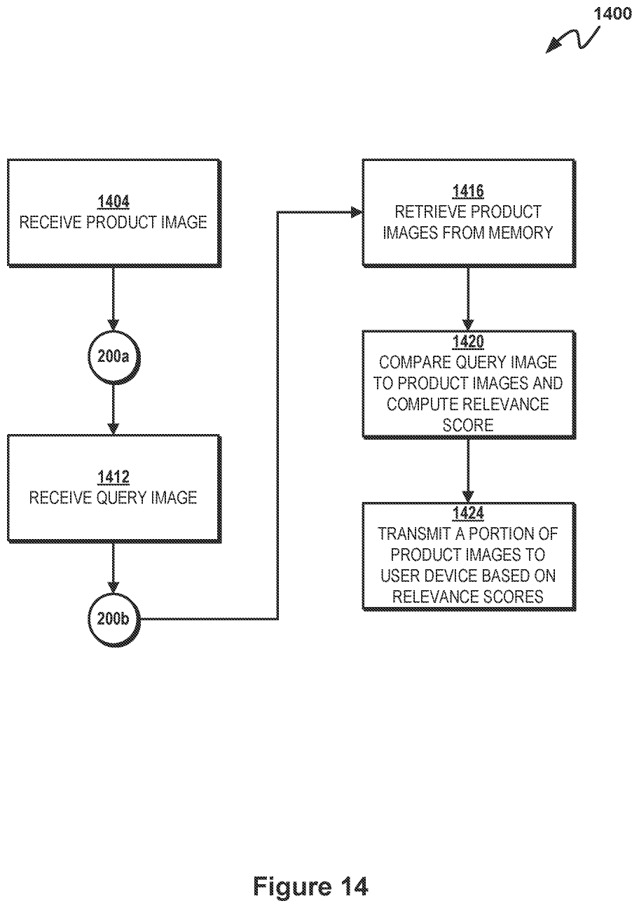

FIG. 14 is a flowchart showing a method 1400 of querying images representing apparel according to one embodiment of the disclosure. Persons skilled in the art may choose to implement method 1400 on system 1300 or variants thereon, or with certain blocks omitted, performed in parallel or in a different order than shown. Method 1400 can thus also be varied.

Block 1404 comprises receiving a product image representing an apparel item. In system 1300, block 1404 is performed by server 100 which receives the product image from computing device 1308 via network 116. In addition to the product image, server 100 may further receive product data associated with the product image and describing attributes of the apparel item. The product data may include seller identity, seller location, price, size, gender, color, brand, fabric, apparel identifier, feature identifier, season, availability, discounts, fit, occasion, shipping options, the like, and combinations thereof. Upon receiving the product image, server 100 may store the product image in memory. If product data is received with the product image, server 100 may further store the product data in association with the product image in memory.

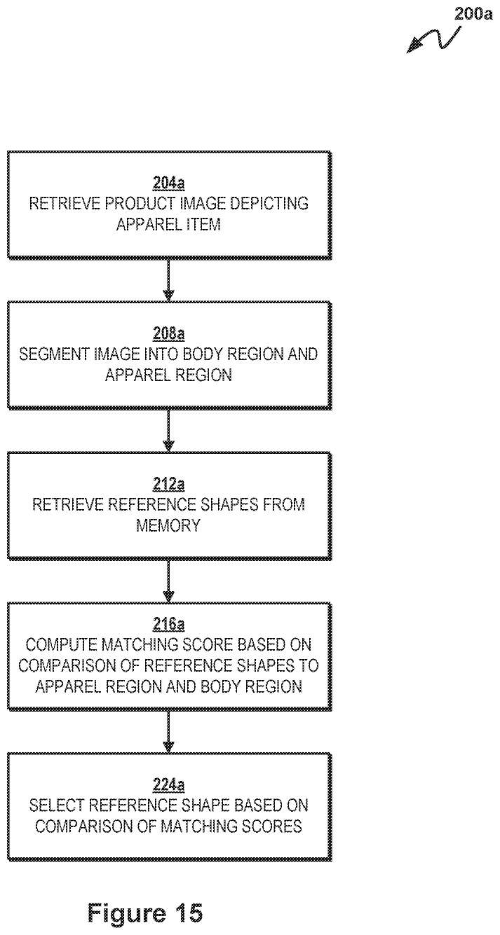

In response to receiving the product image at block 1404, server 100 classifies the product image according to method 200a shown in FIG. 15. Method 200a is a variant on method 200 in which the image classified by server 100 is the product image.

At block 204a, server 100 retrieves from memory the product image. At block 208a, server 100 segments the product image into a body region and an apparel region. At block 212a, server retrieves reference shapes from memory. At block 216a, server computing a matching score for the reference shapes based on a comparison of the reference shapes to the apparel region of the product image and the body region of the product image. At block 224a, server 100 selects at least one of the reference shapes based on a comparison of the matching scores and stores the at least one selected reference shape in memory in association with the product image.

Block 1404 and method 200a may be repeated for a plurality of product images received from one or more computing devices 1308.

Block 1412 comprises receiving a query image from user device 1312. In system 1300, block 1408 is performed by server 100 which receives the query image from user device 1312 via network 116. Generally, the query image depicts an apparel item with characteristics that are desirable to the user.

As part of block 1412, server 100 may further receive one or more search parameters from user device 1312. The search parameter may include a geographic location, price, size, gender, color, brand, fabric, apparel identifier, feature identifier, season, availability, discount, fit, occasion, shipping option, the like, and combinations thereof. The search parameter may include a range of values. In a specific non-limiting example, the search parameter includes price, and the value of the search parameter is $50 to $100. In a further specific non-limiting example, the search parameter includes a geographic location representing the user's location and a search radius around the user's location.

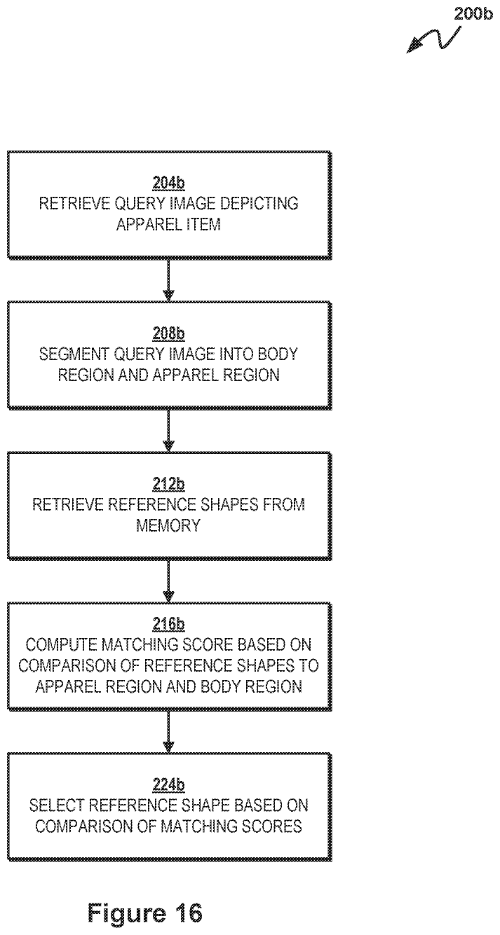

In response to receiving a query image at block 1412, server 100 classifies the query image according to method 200b shown in FIG. 16. Method 200b is a variant on method 200 in which the image classified by server 100 is the query image.

At block 204b, server 100 retrieves from memory the query image. At block 208a, server 100 segments the query image into a body region and an apparel region. At block 212b, server retrieves reference shapes from memory. At block 216b, server 100 computes a matching score for the reference shapes based on a comparison of the reference shapes to the apparel region of the query image and the body region of the query image. At block 224b, server 100 selects at least one of the reference shapes based on a comparison of the matching scores. The selected reference shapes may be stored in memory in association with the reference shape.

Block 1416 comprises retrieving a plurality of product images from memory. In system 1300, block 1416 is performed by server 100 which retrieves product images stored in database 132. Server 100 may retrieve all or a portion of the product images stored in database 132. In examples where server 100 receives a search parameter as part of block 1412, server 100 may retrieve a portion of the product images associated with product data that corresponds to the search parameter. It should be noted that retrieving a portion of the product images at block 1416 can conserve computing resources at server 100. By retrieving only a portion of the product images, block 1420 can be performed on fewer product images, specifically the products images that correspond with the user's search parameters.

Block 1420 comprises comparing the query image to the product images retrieved at block 1416 and computing a relevance score based on the comparison. In system 1300, block 1420 is performed by server 100 which computes a relevance score for each of the retrieved product images based on a comparison between the at least one selected reference shape associated with the product image and the at least one selected reference shapes associated with the query image. The relevance score represents the degree of similarity between the apparel item depicted in the query image and the apparel item depicted in the product image. The relevance score may include a numerical value, a color, a letter, a symbol, a word, the like, or a combination thereof. In one non-limiting example, the relevance score is selected from “high”, “medium”, and “low” wherein “high” is assigned to a product image with a high degree of similarly to the query image and “low” is assigned to a product image with a low degree of similarity to the query image.

In examples where the query image is associated with a plurality of reference shapes, the relevance score may be further based on the number of reference shapes associated with both the query image and product image. Generally, higher relevance scores will be computed for product images that share more style elements with the query image. In one non-limiting example, a first product image is associated with the reference shapes 804-4 and 804-5, a second product image is associated with the reference shapes 804-4 and 804-8, and the query image is associated with the reference shapes 804-4 and 804-5. In this example, server 100 computes a higher relevance score for the first product image than the second product image.

Server 100 may further compute the relevance score based on the matching score for the at least one selected reference shapes associated with the product image and the at least one selected reference shapes associated with the query image.

In a specific non-limiting example, the query image is associated with the reference shape 804-4 corresponding to “side slit (left)” with a matching score of “high” and the product image is associated with the reference shape 804-4 corresponding to “side slit (left)” with a matching score of “medium”. In this example, server 100 may compute a relevance score of “medium” to reflect the uncertainty that the product image depicts a dress with a side slit on the left side. In a further non-limiting example, both the product image and the query image are associated with the reference shape 804-1 (“ballgown”) with a matching score of “high”, the query image is associated with the reference shape 804-6 (“strapless”) with a matching score of “medium”, and the product image is not associated with the reference shape 804-6 (“strapless”). Although the product image does not match the neckline of the dress in the query image, server 100 may nonetheless output a relevance score of “high” based on the uncertainty that the query image is a strapless dress and the likelihood that both the query image and the product image depict ballgowns.

Server 100 may be further configured to compute the relevance score based on a search parameter, product popularity, product rating, seller popularity, seller rating, seller location, purchaser location, the like, and combinations thereof. In examples where server 100 calculates the relevance score based on a search parameter, the search parameter includes at least one of an apparel identifier, a feature identifier, and a variant identifier. Server 100 increases the relevance score for product images that are associated with a reference shape corresponding to said apparel identifier, feature identifier or variant identifier. In a specific non-limiting example, the search parameter includes the feature identifier “neckline” and server 100 computes a high relevance score for product images that correspond with the neckline shown in the query image. Generally, modifying the relevance score based on a search parameter allows the purchaser to prioritize features of the apparel item that are most important to them. This reduces the likelihood that purchasers will receive search results that do not match their preferences.

Having computed the relevance score, server 100 may store the relevance score in memory in association with the product image and the query image.

Block 1424 comprises transmitting a portion of the product images to the user device based on the relevance scores calculated at block 1420. In system 1300, block 1424 is performed by server 100 which transmits the portion of the product images via network 116.

The portion of product images may comprise the product images corresponding to the highest relevance scores. The portion of product images may comprise the product images having a relevance score that meets or exceeds a pre-determined threshold. Processor 104 may be programmed with a pre-determined number and the pre-determined number of product images having the highest relevance scores.

It should be understood that block 1424 conserves networking and computing resources in system 1300. By selecting a portion of the product images, server 100 transmits the portion of the product images which are more likely to be relevant to the user. The user device 1312 is less likely to receive product images that are irrelevant to their search query and therefore less likely to repeat the search.

In response to receiving the portion of product images, user device 1312 is configured to display the portion of product images at a display connected to user device 1312. In some examples, user device 1312 displays the product images in order of relevance score, from highest relevance score to lowest relevance score.

In view of the above, it will now be apparent that variants, combinations, and subsets of the foregoing embodiments are contemplated. For example, method 1400 was described as including both method 200a and 200b, however in other examples, method 1400 includes either method 200a or 200b. In examples where method 200a is omitted, the query image is classified using reference shapes and product images are selected for transmission to the user device 1312 based on keyword matching between the product data and the reference shape associated with the query image. In examples where method 200b is omitted, product images are classified using reference shapes and product images are selected for transmission to the user device 1312 based on keyword matching between the search parameters and the reference shapes associated with the product images.

It will now be apparent to a person of skill in the art that the present specification affords certain advantages over the prior art methods of categorizing apparel in images. By identifying fashion styles in query and product images, the server is more likely to deliver search results that are relevant to the purchaser, which will ease user frustration and reduce the time required to find a relevant apparel item. Since users will need to scroll through fewer search results and conduct fewer searches, computing and networking resources can be conserved across the system. The method and server can also allow vendors to upload retail listings in less time, since they will not need to manually input a detailed product description. Furthermore, since search results are based on image characteristics, the server does not rely on machine and human translations, which are prone to errors, in order to deliver relevant search results to a purchaser.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for classifying apparel in images, the method comprising:
receiving at a computing device an image depicting an apparel item and a body;
at a processor connected to the computing device, segmenting the image into at least a body region corresponding to the body and an apparel region corresponding to the apparel item;
retrieving a plurality of reference shapes from memory at the computing device;
at the processor, computing a matching score for each of the reference shapes, the matching score representing a comparison of the respective reference shape to the body region and the apparel region; and
at the processor, selecting one of the reference shapes based on a comparison of the matching scores.

2. The method of claim 1 wherein segmenting the image comprises:
differentiating colors in the image;
determining a boundary of the apparel region based on the color differentiation; and
determining a boundary of the body region based on the color differentiation.

3. The method of claim 2 further comprising generating a geometric model of the body based on the segmentation, wherein computing a matching score for each of the reference shapes includes comparing the respective reference shape to the geometric model.

4. The method of claim 3 wherein the geometric model of the body comprises a plurality of body coordinates connected by vectors.

5. The method of claim 4 wherein generating the geometric model of the body comprises:
detecting keypoints corresponding with the body depicted in the image;
assigning one of the body coordinates to each of the keypoints; and
connecting the body coordinates with the vectors.

6. The method of claim 4 wherein generating the geometric model of the body comprises:
estimating a pose based on the boundary of the body region and the boundary of the apparel region;
locating the plurality of body coordinates in the image based on the pose; and
connecting the body coordinates with vectors.

7. The method of claim 2 wherein computing the matching score for each of the reference shapes comprises comparing the respective reference shape to the geometric model of the body.

8. A non-transitory computer-readable medium comprising instructions for classifying images, the instructions for:
receiving at a computing device an image depicting an apparel item and a body;
at a processor connected to the computing device, segmenting the image into at least a body region corresponding to the body and an apparel region corresponding to the apparel item;
retrieving a plurality of reference shapes from memory at the computing device;
at the processor, computing a matching score for each of the reference shapes, the matching score representing a comparison of the respective reference shape to the body region and the apparel region; and
at the processor, selecting one of the reference shapes based on a comparison of the matching scores.

9. The non-transitory computer-readable medium of claim 10, wherein the instructions for segmenting the image comprise:
differentiating colors in the image;
determining a boundary of the apparel region based on the color differentiation; and
determining a boundary of the body region based on the color differentiation.

10. The non-transitory computer-readable medium of claim 9, the instructions further comprising generating a geometric model of the body based on the segmentation, wherein computing a matching score for each of the reference shapes includes comparing the respective reference shape to the geometric model.

11. The non-transitory computer-readable medium of claim 10, wherein the geometric model of the body comprises a plurality of body coordinates connected by vectors.

12. The non-transitory computer-readable medium of claim 11, wherein the instructions for generating the geometric model of the body comprise:
detecting keypoints corresponding with the body depicted in the image;
assigning one of the body coordinates to each of the keypoints; and
connecting the body coordinates with the vectors.

13. The non-transitory computer-readable medium of claim 11, wherein generating the geometric model of the body comprises:
estimating a pose based on the boundary of the body region and the boundary of the apparel region;
locating the plurality of body coordinates in the image based on the pose; and
connecting the body coordinates with vectors.

14. The non-transitory computer-readable medium of claim 9 wherein computing the matching score for each of the reference shapes comprises comparing the respective reference shape to the geometric model of the body.

15. A method for querying images comprising:
receiving a plurality of product images at a server;
classifying the product images according to the method of claim 1;
at the server, receiving a query image from a user device via a network;
classifying the query image according to the method of claim 1;
comparing the query image to the product images and computing a plurality of relevance scores based on the comparison;
comparing the relevance scores; and
transmitting a portion of the product images to a user device based on the comparison of the relevance scores.

16. A system for querying images, the system comprising:
a network;
a user device configured to transmit a query image via the network; and
a server comprising a processor, the server configured to:
classify a plurality of product images according to the method of claim 1 and store the plurality of product images in memory at the server;
receive the query image from the user device;
classify the query image according to the method of claim 1;
compare the query image to the plurality of product images and compute a relevance score for the plurality of product images based on the comparison;
compare the relevance scores; and
transmit a portion of the product images to the user device based on a comparison of the relevance scores.
